(19) United States
(12) Patent Application Publication
(10) Pub. No.: US 2013/0226548 A1
(43) Pub. Date: Aug. 29, 2013

(54) SYSTEMS AND METHODS FOR ANALYSIS TO BUILD PREDICTIVE MODELS FROM MICROSCOPIC CANCER IMAGES

(71) Applicant: The Board of Trustees of the Leland Stanford Junior University, (US)

(72) Inventors: Andrew H. Beck, Brookline, MA (US); Daphne Koller, Portola Valley, CA (US)

(73) Assignee: The Board of Trustees of the Leland Stanford Junior University, Palo Alto, CA (US)

(21) Appl. No.: 13/773,288

(22) Filed: Feb. 21, 2013

Related U.S. Application Data
(60) Provisional application No. 61/602,358, filed on Feb. 23, 2012.

(51) Int. Cl. G06F 19/12

(52) U.S. Cl. CPC G06F 19/12
USPC 703/11

(57) ABSTRACT

Aspects of the present disclosure are directed towards methods, apparatus, and systems that predict a survival outcome for a patient using a prognostic model and cancer tissue image data from the patient. Cancer data is received, and superpixels are constructed that are representative of the data. Nuclear and cytoplasmic features are constructed for the superpixels based upon the image data and nuclei within the superpixels, and the superpixels are classified as epithelium or stroma based thereon. Relational feature data is computed for both the epithelium superpixels and the stroma superpixels, and a prognostic model is constructed based on the relational feature data.

### BACKGROUND

It is difficult to develop a computer algorithm that could essentially “be” a pathologist (providing an objective readout for tumor grade) for various reasons. The human brain is exceptional at pattern recognition, and pathology specialization is a skill honed to an extreme degree. The result is the ability to classify specific entities on the basis of various criteria, such as benign versus malignant or invasive versus in situ malignancy. The simplest features are easily described; for example, a high nuclear-to-cytoplasmic ratio and coarse chromatin. However, some features are difficult to describe, hard to teach, and, in turn, hard to learn; often requiring more than 10 years before a pathologist can be considered an “expert.” One of the most critical subjective tumor evaluation parameters is histologic grade. Although there are standardized criteria for grading different histologies, the agreement between pathologists is variable. As a result, it has been notoriously difficult to emulate that expertise with a machine.

### SUMMARY

Aspects of the present disclosure are directed towards apparatus, systems, and methods that are useful in predicting a survival outcome of a patient using a prognostic model. Included in these aspects are, for example, a circuit-based processor that carries out various operations. Included in these operations is the construction of superpixels representative of received cancer tissue image data. Each superpixel includes pixels from a region within the image data. The operations also involve construction of nuclear and cytoplasmic features for the superpixels based upon the image data and nuclei within the superpixels. The superpixels are classified as being one of epithelium superpixels or stroma superpixels (based upon the nuclear and cytoplasmic features). Relational feature data is computed for objects in the epithelium superpixels and, separately, for objects in the stroma superpixels. The relational feature data, based on the epithelium superpixels, is indicative of both morphologic and spatial relationships between the objects in the epithelium superpixels. The relational feature data, based on the stroma superpixels, is indicative of both morphologic and spatial relationships between adjacent ones of the objects in the stroma superpixels. A prognostic model is constructed based upon the relational feature data for both the epithelium superpixels and stroma superpixels, and a survival outcome is predicted for a patient using the prognostic model and cancer tissue image data from the patient.

The above discussion is not intended to describe each embodiment or every implementation. The figures and following description also exemplify various embodiments.

### FIGURES

Various example embodiments may be more completely understood in consideration of the following detailed description in connection with the accompanying drawings, and those in the Appendices as were filed as part of the underlying provisional application.

FIG. 1 shows an example module-level diagram of a data computing circuit, consistent with various aspects of the present disclosure;

FIG. 2 shows an example apparatus including an imaging arrangement, a processor arrangement and a display, consistent with various aspects of the present disclosure;

FIG. 3A shows basic image processing and feature construction of obtaining a cancer image data, consistent with various aspects of the present disclosure;

FIG. 3B shows the separation of epithelial and stroma cells which is used for an image-based construction of an epithelial/stromal classifier, consistent with various aspects of the present disclosure

FIG. 3C shows a high level construction of contextual/relational features consistent with various aspects of the present disclosure; and

FIG. 3D shows a high-level illustration of processed images from patients, consistent with various aspects of the present disclosure.

While the disclosure is amenable to various modifications and alternative forms, examples thereof have been shown by way of example in the drawings and will be described in detail. It should be understood, however, that the intention is not to limit the disclosure to the particular embodiments shown and/or described. On the contrary, the intention is to cover all modifications, equivalents, and alternatives falling within the spirit and scope of the disclosure.

### DETAILED DESCRIPTION

Systems, methods, and apparatus of the present disclosure are directed towards a machine-based prognostic and/or diagnostic assessment of cancer tissue image data. Using a machine-based model to assess cancer image data allows for fast, accurate, and high-thoroughput prognostic and/or diagnostic evaluation of a patient.

Certain aspects of the present disclosure are directed toward a circuit-based processor, and use thereof, that carries out various operations by using a plurality of circuit-based modules. In some embodiments, the circuit-based processor includes a construction module that constructs superpixels representative of received cancer tissue image data. Each superpixel includes pixels from a region within the image data. In certain embodiments, the superpixels are further defined as having less complexity than the image data, while maintaining a coherent appearance of the region of within each image frame. In certain embodiments, the superpixels are constructed by applying a series of image processing algorithms to break the image into coherent superpixels. Nuclear and cytoplasmic features are constructed for the superpixels based upon the image data and nuclei within the superpixels. In certain embodiments, the nuclear and cytoplasmic features are constructed in a manner that decreases complexity of the image data while maintaining morphologic and spatial relationships between objects in a region within each image frame.

An additional module included in the circuit-based processor is an epithelium/stroma classifer module. Based upon the nuclear and cytoplasmic features in the superpixels, the epithelium/stroma classifer module classifies the superpixels as being one of epithelium superpixels or stroma superpixels. A relational module is included with the circuit-based processor to compute relational feature data for objects in the epithelium superpixels, and to compute relational feature data for objects in the stroma superpixels. For the epithelium superpixels, the relational feature data is indicative of both morphologic and spatial relationships between the objects in the epithelium superpixels. For the stroma superpixels, the relational feature data being indicative of both morphologic and spatial relationships between adjacent ones of the objects in the stroma superpixels.

One or more apparatuses, methods, and systems consistent with aspects of the present disclosure also include a prognostic module as a part of the circuit-based processor. The prognostic module constructs a prognostic model based upon the relational feature data for both the epithelium superpixels and stroma superpixels. A survival module, provided as a part of the circuit-based processor, predicts a survival outcome for a patient. The survival module uses the prognostic model constructed by the prognostic module and cancer tissue image data from the patient in predicting the survival outcome.

In certain more specific embodiments of the present disclosure, the relational module, in computing the relational feature data for objects in the stroma superpixels, will also assess differences of the objects with its neighbors by determining variability of stromal matrix intensity differences therebetween. Additionally, in such embodiments, the prognostic module predicts a high likelihood of survival when there is a high variability of stromal matrix intensity differences. Further, the relational module, in computing the relational feature data for objects in the stroma superpixels, in certain embodiments, also computes at least one of the following: variability of stromal matrix intensity differences; sum of a minimum intensity value of stromal-contiguous regions; and measure of a relative border between spindled stromal nuclei and round stromal nuclei. In certain embodiments of the present disclosure, the relational module computes the relational feature data for objects in the epithelium superpixels by computing at least one of the following: standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions. In certain embodiments of the present disclosure, the prognostic module constructs a prognostic model based on computing at least one or more of the above identified stroma-related computations, and the epithelium-related computations.

In certain embodiments, the relational module computes relational feature data for adjacent objects in computing at least one of the relational feature data for objects in the epithelium superpixels and the relational feature data for objects in the stroma superpixels. Additionally, in other embodiments, the relational module computes the relational feature data includes identifying morphologic and spatial relationships having a confidence interval of at least 95% for predicting the survival outcome, and computes data for adjacent objects using the identified morphologic and spatial relationships.

The relational module, in other embodiments of the present disclosure, determines variability of stromal matrix intensity differences between adjacent objects in computing the relational feature data for objects in the stroma superpixels, and the prognostic module associates the determined variability of stromal matrix intensity differences in the prediction of the survival outcome.

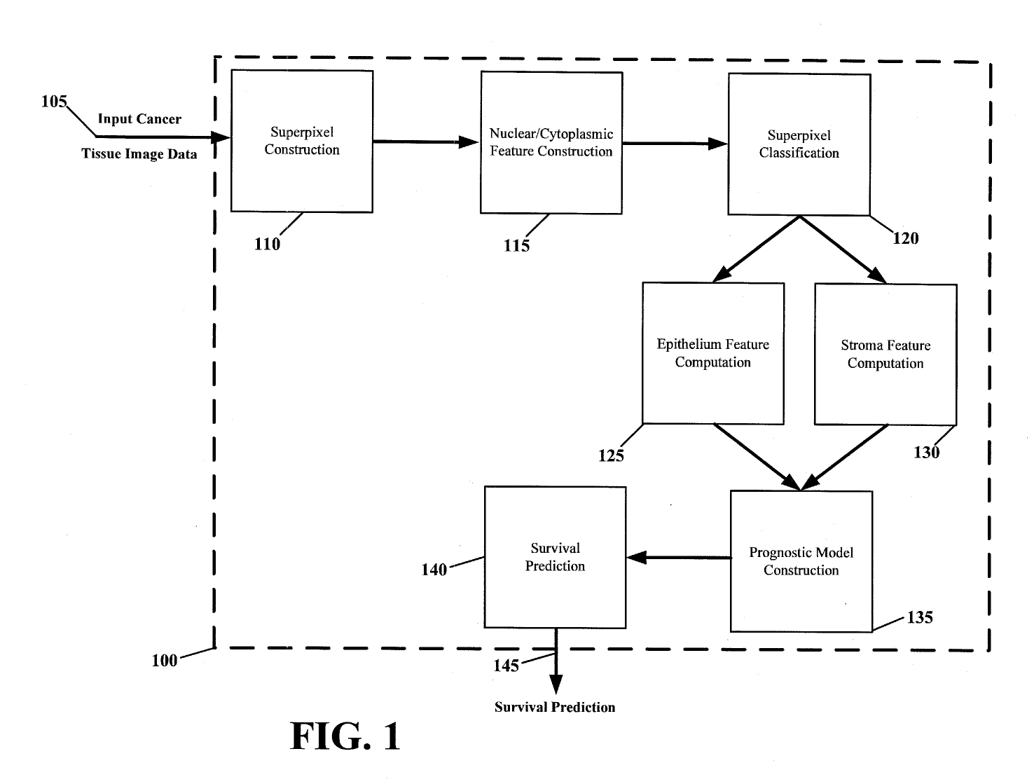

Turning now to the figures, FIG. 1 shows an example module-level diagram of a data computing circuit 100, consistent with various aspects of the present disclosure. The data computing circuit 100 includes a number of different modules that carry out various operations. First, cancer tissue image data is input 105 into the data computing circuit 100, and provided to the superpixel construction module 110. The superpixel construction module 110 constructs superpixels representative of received cancer tissue image data with each superpixel including pixels from a region within the image data. The superpixel construction module 110 can be designed to construct superpixels that have less complexity than the image data, but maintain a coherent appearance of the region of within each image frame. The superpixel construction module 110 constructs coherent superpixels by applying a series of image processing algorithms to breakdown the image.

Additionally included in the data computing circuit 100 is a nuclear/cytoplasmic feature construction module 115. The nuclear/cytoplasmic feature construction module 115 operates in conjunction with the superpixel construction module 110 to construct nuclear and cytoplasmic features for the superpixels based upon the image data and nuclei within the superpixels. The nuclear/cytoplasmic feature construction module 115 can construct these features without decreasing complexity of the image data, and still maintain the morphologic and spatial relationships between objects in a region within each image frame.

Data is passed from the nuclear/cytoplasmic feature construction module 115 (and the superpixel construction module 110) to a superpixel classification module 120 that operates by classifying epithelium and stroma, and therefore can also be deemed to be an epithelium/stroma classifier module. The nuclear/cytoplasmic feature construction module 115 classifies the superpixels as being one of epithelium superpixels or stroma superpixels based upon the nuclear and cytoplasmic features in the superpixels. After the nuclear/cytoplasmic feature construction module 115 classifies the superpixels as either epithelium or stroma, data is passed to a relational module that is shown in FIG. 1 in two parts: an epithelium feature computation module 125, and a stroma feature computation module 130. The epithelium feature computation module 125 and the stroma feature computation module 130 compute relational feature data for objects in the epithelium superpixels and stroma superpixels, respectively.

The relational feature data calculated by the epithelium feature computation module 125 is indicative of both morphologic and spatial relationships between the objects in the epithelium superpixels. The relational feature data calculated by the stroma feature computation module 130 is indicative of both morphologic and spatial relationships between adjacent ones of the objects in the stroma superpixels. In certain embodiments, at least one the epithelium feature computation module 125 and the stroma feature computation module 130 computes relational feature data by also computing relational feature data for adjacent objects.

In certain embodiments, the stroma feature computation module 130 computes the relational feature data for objects in the stroma superpixels based on an assessment of differences with neighboring objects by determining variability of stromal matrix intensity differences between adjacent objects in the stroma superpixels. Further, the stroma feature computation module 130 also can compute the relational feature data for objects in the stroma superpixels by computing at least one of the following: variability of stromal matrix intensity differences; sum of a minimum intensity value of stromal-contiguous regions; and measure of a relative border between spindled stromal nuclei and round stromal nuclei.

In certain embodiments of the present disclosure, the epithelium feature computation module 125 computes the relational feature data for objects in the epithelium superpixels by also computing at least one of the following: standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

The epithelium feature computation module 125 and the stroma feature computation module 130 pass the relational feature data to a prognostic model construction module 135. The prognostic model construction module 135 constructs a prognostic model based upon the relational feature data for both the epithelium superpixels and stroma superpixels. Using the prognostic model constructed by the prognostic model construction module 135 (and cancer tissue image data from the patient), a survival prediction module 140 predicts a survival outcome for a patient. After this prediction by the survival prediction module 140, data can be output from the data computing circuit 100. In certain embodiments, the prognostic model construction module 135 constructs the prognostic model based upon at least one of the following features: variability of stromal matrix intensity differences; sum of a minimum intensity value of stromal-contiguous regions; measure of a relative border between spindled stromal nuclei and round stromal nuclei; standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

In certain embodiments, the computation of relational feature data by the epithelium feature computation module 125 and the stroma feature computation module 130 includes identifying morphologic and spatial relationships having a confidence interval of at least 95%. Based on this identification, the prognostic model construction module 135 predicts the survival outcome, and computes data for adjacent objects which use the identified morphologic and spatial relationships.

In certain embodiments, the stroma feature computation module 130 computes the relational feature data for objects in the stroma superpixels based on an assessment of differences with neighboring objects by determining variability of stromal matrix intensity differences between adjacent objects in the stroma superpixels, and the prognostic model construction module 135 associates the survival outcome of a patient with a high variability of stromal matrix intensity differences.

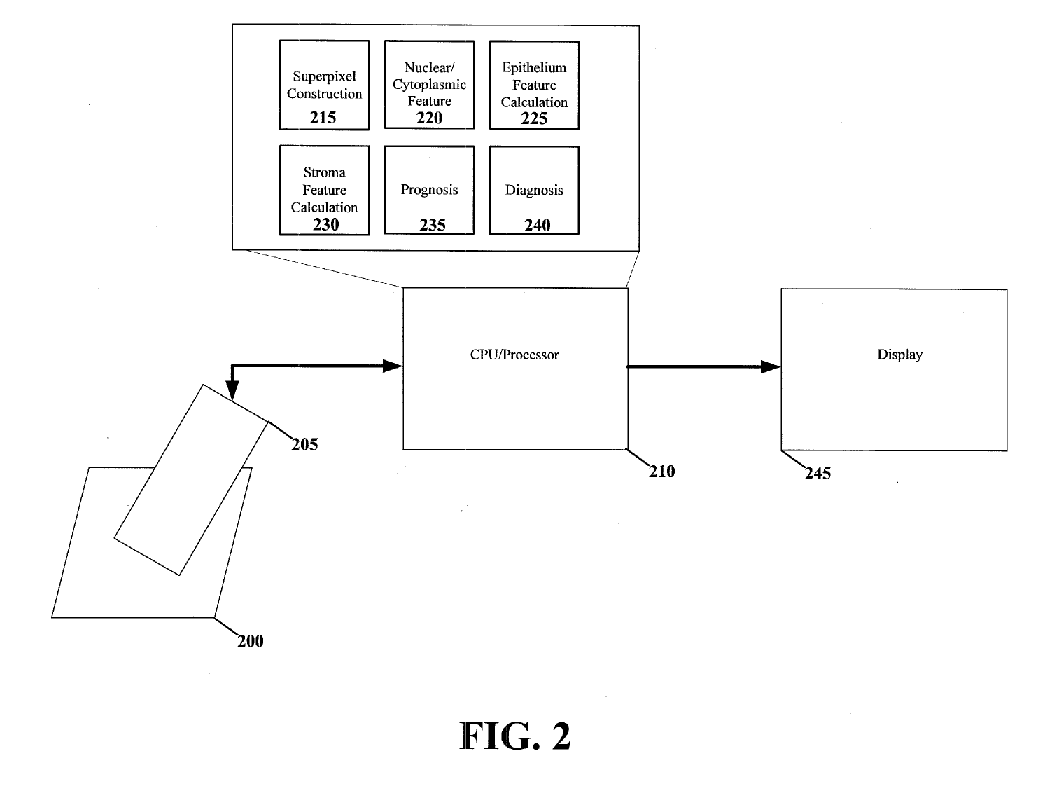

FIG. 2 shows an example apparatus including an imaging arrangement 205, a processor arrangement 210 and a display 245, consistent with various aspects of the present disclosure. The imaging arrangement 205 is provided in order to collect data from cancer imaging at position 200 for analysis. The data collected at position 200 can be based on cancer tissue that has been dyed. Dying of the tissue will provide differentiation between the aspects of the cancer tissue that are used for analysis. Dying of the tissue can be accomplished by any appropriate machine (e.g., Ventana's BenchMark Special Stains). The imaging arrangement 205 collects data by capturing images of the cancer tissue. Thus, the imaging arrangement 205 can be of any desired form, such as a microscope arrangement, or even a high-throughput scan slider (e.g., Ventana's iScan HT) that can efficiently record images from multiple slides in a single loaded effort.

The data collected by the imaging arrangement 205 is provided to a circuit-based processor 210. Included in this circuit-based processor 210 are a number of different modules used for analysis, such as the modules discussed in detail relative to FIG. 1. The circuit-based processor 210 shown in FIG. 2 includes a superpixel construction module 215, a nuclear/cytoplasmic feature construction module 220, an epithelium feature calculation module 225, a stroma feature calculation module 230, a prognostic module 235 (a combination of the prognostic model construction module 135 and the survival prediction module 140 of FIG. 1), and a diagnostic module 240. The diagnostic module 240 is the only module not discussed in detail relative to FIG. 1. This module, utilizing the same analysis of the applied in the prognostic model construction module 135, analyzes the cancer tissue samples for diagnosis of a type of cancer that a patient is suffering from. The analysis provided by the circuit-based processor 210 is subsequently shown to a user on the display 245.

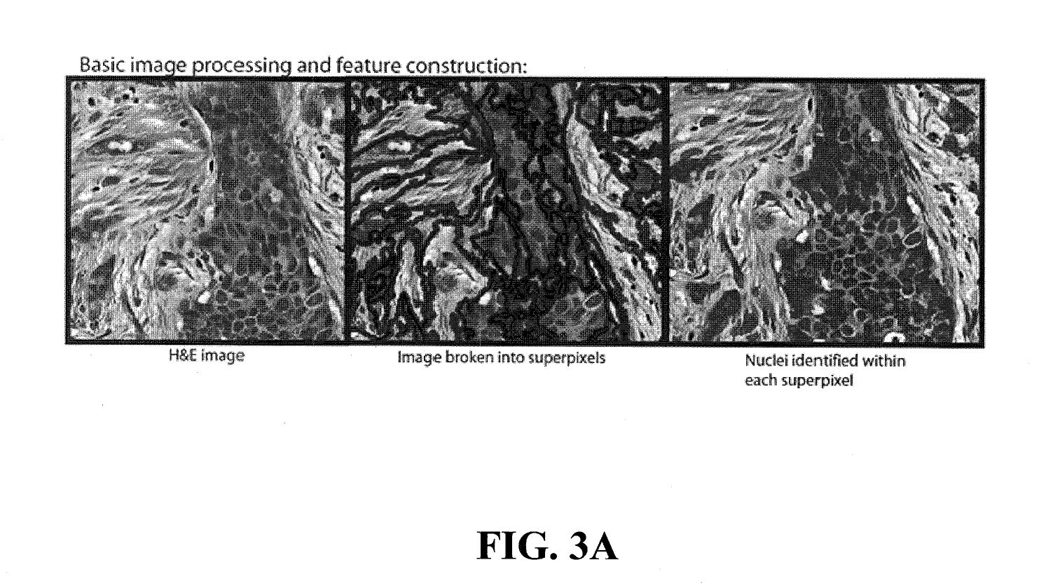

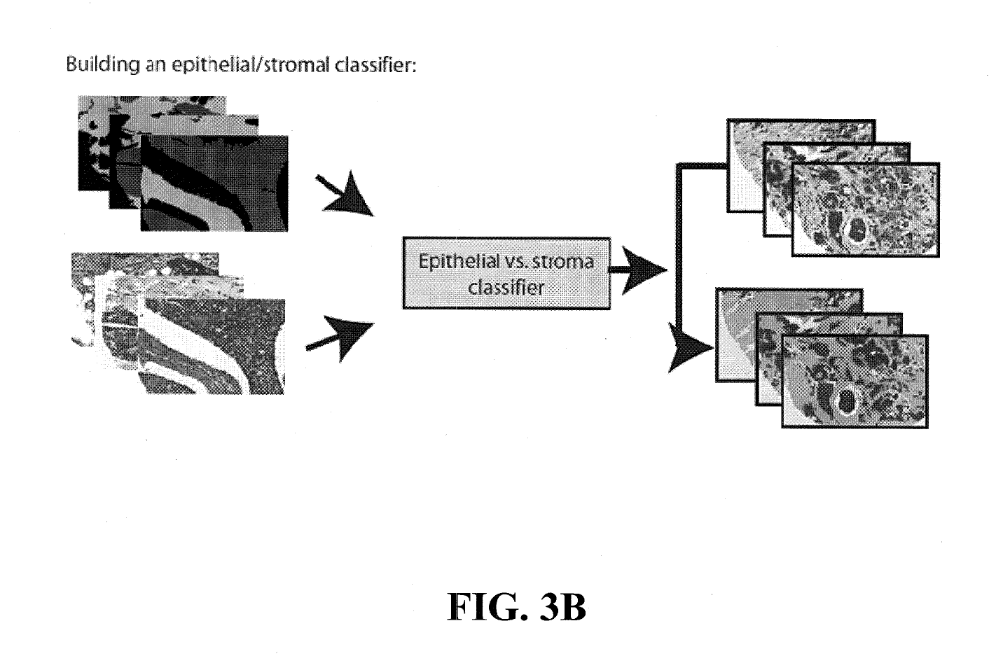

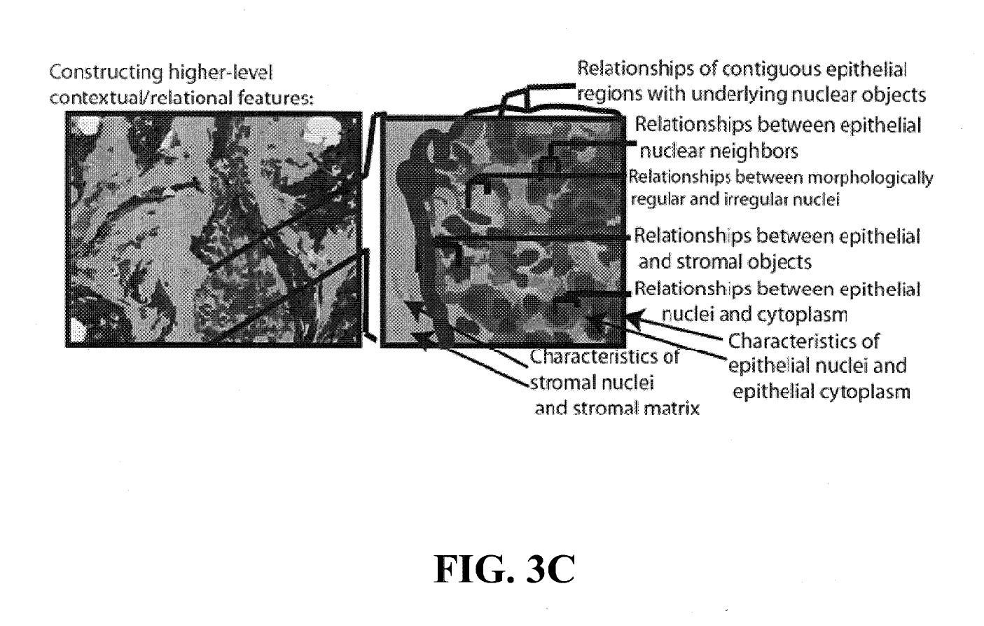

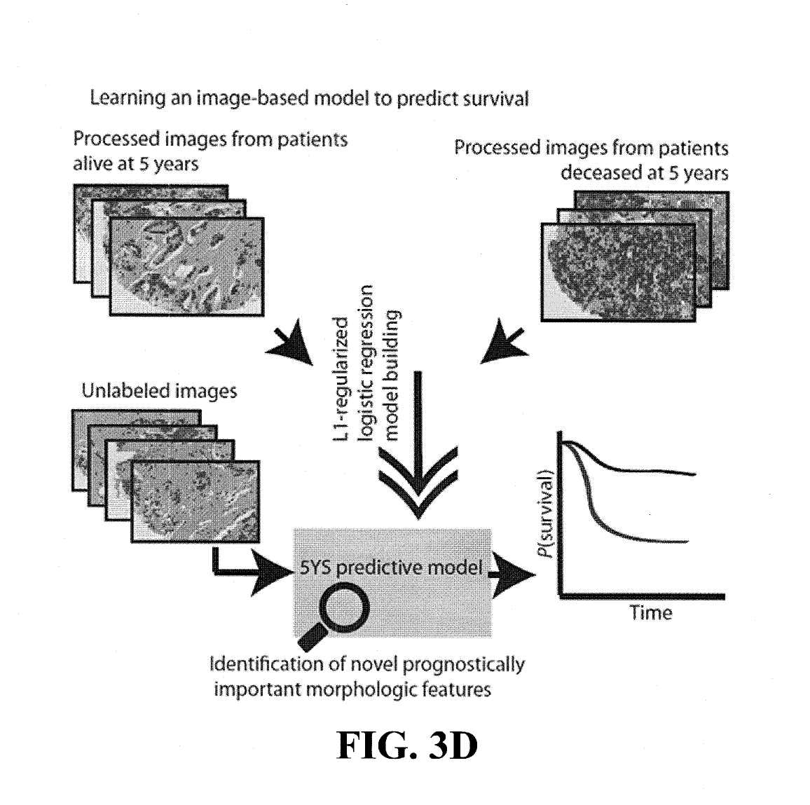

FIG. 3 shows an example imaging-based overview of processing image data and building a prognostic model. FIG. 3A shows the basic image processing and feature construction, consistent with various aspects of the present disclosure, of obtaining a cancer image data. Imaging processing is also utilized to separate the tissue image from the background image, and therefore partition the image into small regions of coherent appearance known as superpixels. In this manner, the processor can find nuclei within the superpixels, and construct nuclear and cytoplasmic features within the superpixels. FIG. 3B shows the separation of epithelial and stroma cells which is used for an image-based construction of an epithelial/stromal classifier, consistent with various aspects of the present disclosure. FIG. 3C shows a high level construction of contextual/relational features. For instance, within each superpixel, the intensity, texture, size, and shape of the superpixel and its neighbors can be measured. FIG. 3D provides a high-level illustration of processed images from patients that were deceased at 5-years, and patients suffering from the same type of cancer that were deceased at 5-years. Analysis of these images by the circuit-based processor, consistent with various aspects of the present disclosure, allows for a machine learning type approach for the prognostic module to accurately predict survival rates.

Various aspects of the present disclosure are directed toward systems, methods, and apparatus that employ computational pathology utilizing 6642 features to synthesize a scoring system to predict outcome in cancer. Rather than being user- or pathologist-defined, tissue features can be chosen by the image-processing system. The image-processing system defines features as both standard morphometric descriptors of image objects and higher-level contextual, relational, and global image features, which may not be sensible to pathologists. The image-processing system can collect features from both epithelial and stroma locations in cancer tissue. Thereafter, machine-learning can be used to define features that were associated with a binary outcome (e.g., patient survival).

Certain embodiments of systems, methods, and apparatus, consistent with various aspects of the present disclosure can be highly statistically significant in prediction of cancer patient survival. Analysis of the feature set can show both epithelial and stromal features, regularly by pathologists, but is typically challenging for computer-based systems as finding epithelial features has been a common first step.

Certain other embodiments of systems, methods, and apparatus, consistent with various aspects of the present disclosure, measure an extensive, quantitative feature set from the cancer epithelium and the stroma. The following discussion focuses on the analysis of breast cancer epithelium and stroma, however, the systems, methods, and apparatus of the present disclosure can be utilized for analysis of other cancer types. The systems, methods, and apparatus first perform an automated, hierarchical scene segmentation that generates thousands of measurements, which include both standard morphometric descriptors of image objects and higher-level contextual, relational, and global image features.

Certain embodiments of the prognostic model utilize a machine learning approach (L1-regularized logistic regression), to train the epithelium/stroma classifier (in which superpixels from 158 images were hand-labeled). The resulting classifier includes 31 features, and can achieve a classification accuracy of 89%. To construct a final set of features to be used in a prognostic model, values of the basic features were computed separately within the epithelium and stroma. Nuclei are subclassified as “typical” or “atypical”, and object measurements from contiguous epithelial and stromal regions, as well as from epithelial nuclei, epithelial atypical nuclei, epithelial cytoplasm, stromal round nuclei, stromal spindled nuclei, stromal matrix, and unclassified objects were obtained. A range of relational features are computed that capture the global structure of the sample and the spatial relationships among its different components, such as: mean distance from epithelial nucleus to stromal nucleus; mean distance of atypical epithelial nucleus to typical epithelial nucleus; or distance between stromal regions. As a result, a set of 6642 features can be analyzed per image.

A purpose of the disclosure is to provide an image analysis system for extracting a rich quantitative feature set from cancer microscopic images and to use these features to build clinically useful predictive models.

Based on the image-based model, patient outcome is predicted. Further, clinically significant morphologic features are identified. Laborious image object identification, typically accomplished by skilled pathologists, followed by the measurement of a small number of expert predefined features, primarily characterizing epithelial nuclear characteristics, such as size, color, and texture can be overcome by the methods and systems of the present disclosure. For example, after initial filtering of images to ensure high-quality tissue microarray (TMA) images, and training/calibration of the models using expert-derived image annotations (epithelium and stroma labels to build the epithelial-stromal classifier and survival time and survival status to build the prognostic model), the methods and systems of the present disclosure directed towards image analysis are automated with no manual steps, thereby greatly increasing scalability, efficiency, and reduce costs. Further, aspects of the present disclosure are directed towards the measure of thousands of morphologic descriptors of diverse elements of the microscopic cancer image, including many relational features from both the cancer epithelium and the stroma, allowing identification of prognostic features previously unrecognized as being significant.

The prognostic model, consistent with the present disclosure, can be a strong predictor of survival, and can provide significant additional prognostic information to clinical, molecular, and pathological prognostic factors in a multivariate model. Further, this image-based prognostic model can be a strong prognostic factor on other independent data sets with very different characteristics. Such findings indicate that the prognostic model, consistent with the present disclosure, can be adapted to provide an objective, quantitative tool for histologic grading of invasive cancer (e.g., breast cancer) in clinical practice.

Microscopic images of cancer samples represent a rich source of biological information because this level of resolution facilitates the detailed quantitative assessment of cancer cells' relationships with each other, with normal cells, and with the tumor microenvironment. These relationships all represent key “hallmarks of cancer.” In certain embodiments of the present disclosure, of the top eleven features most robustly associated with survival in a bootstrap analysis, eight are from the epithelium and three are from the stroma. Certain prognostic models built on only the three stromal features, for example, can be a stronger predictor of patient outcome than a model based on the epithelial features. Further, in certain embodiments, a model based only on stromal features can be equally as predictive as the model built from all features. The stromal features include a measure of stromal inflammation (implicated in breast cancer progression) as well as several previously unrecognized stromal morphologic features that can be prognostically significant in breast cancer. Therefore, based on the prognostically successful model only utilizing stromal features, stromal morphologic structure can be an important prognostic factor in cancer.

In other embodiments of the present disclosure, the image-based systems and methods can be adapted for use to evaluate the response of cells to specific pharmacological agents. Additionally, the image-based systems and methods can be adapted to evaluate phenotypic consequences of molecular changes in cancer.

Various image-based systems and methods in accordance with one or more embodiments of the present disclosure utilize image analysis within a Definiens Image Analysis Environment. The flowing discussion focuses on the experimental development and implementation of the relational and morphological features utilizing a processor or CPU arrangement (e.g., programmed with the Definiens Image Analysis Environment), and the algorithms used for image analysis. Various related embodiments are discussed in greater detail in Appendix B of the underlying provisional application. Each image (saved as .jpg for example) of each core can be read into the workspace with predefined generic image import with one .jpg image per scene. The epithelial-stromal image layer can be created with a “Multiresolution Segmentation” algorithm applied to the pixel level. This algorithm applies an optimization procedure that locally minimizes the average homogeneity for image objects comprised of pixels. Three user-defined parameters are input into the algorithm: a scale parameter (which influences the size of resulting superpixels) and shape and compactness parameters that contribute to the “homogeneity criterion.” A scale parameter of 150, shape parameter of 0.5, and compactness parameter of 0.3 can be used. The segmentation algorithm uses a mutual-best fitting procedure to create image objects that maximize intra-object homogeneity and inter-object heterogeneity.

To identify nuclear regions within the superpixels, an auto threshold algorithm can be applied on the layer 1 (Red) pixel values to identify an adaptive threshold for classifying image objects based on darkness. A multi-threshold segmentation algorithm then can be applied on the pixel level to identify and segment nuclei based on pixel intensity with a minimum object size of 200 pixels. The objects obtained are classified as either darker than or lighter than the threshold. This procedure creates objects based solely on pixel intensity. To use size, shape, and intensity information to inform segmentation of nuclei, multi-resolution segmentation (with a scale parameter of 20, shape criteria of 0.9, and compactness criteria of 0.1) can be performed on the darker objects obtained from the multi-threshold segmentation. After this step of segmentation, the object can be subclassified as a “regular nuclei” if its area was 135-750 pixels, roundness less than 0.9, and ratio of 3 length\width less than or equal to 5. All other darker objects were labeled “atypical nuclei.”

Approximately 112 features from each superpixel that had been hand-labeled as either epithelium or stroma are utilized to train the epithelial/stromal classifier. L1 regularized logistic regression can be applied to build an epithelial/stromal classifier. The λ parameter was selected that achieved a classification error within 1 standard error of the minimum classification error on the held-out cases during 10-fold cross-validation. The resulting model contained 31 features with non-zero coefficients.

The 31 feature logistic regression classifier can be then applied to all superpixels, which created a probability score indicating the predicted probability that the superpixel is epithelial (values greater than or equal to 0.5) or stromal (values <0.5). To focus analysis on high-confidence areas of epithelium and stroma, all superpixels can be labeled with an epithelial-stromal classifier score greater than or equal to 0.75 as epithelium and all superpixels with an epithelial-stromal classifier score less than 0.25 as stroma. The remaining superpixels can be left unlabeled.

After the classification of superpixels as epithelium or stroma, adjacent superpixels from the same class can be merged with each other resulting in the creation of epithelial and stromal superpixels. The shape and size of the epithelial and stromal superpixels reflect the structure of contiguous epithelial and stromal regions in the image.

Each sub-cellular object can be relabeled based on the classification of its parent superpixel. This resulted in the following sub-cellular object classes: epithelial regular nucleus, epithelial atypical nucleus, epithelial cytoplasm, stromal round nucleus, stromal spindled nucleus, stromal matrix, unclassified regular nucleus, unclassified atypical nucleus, and the classification of background for sub-cellular objects whose parent object can be classified as background. The preceding steps carried out a hierarchical segmentation of each image, which broke the image into two layers of resolution: a superpixel layer and a sub-cellular layer. Each layer includes a set of objects that each had a classification label. 164 features from each superpixel image object can be measured, and summarized separately for epithelial, stromal, and background superpixels. Prior to analysis, each feature can be summarized by its mean, min, max, standard deviation and sum. Measured features can include: standard morphometrical features (superpixel intensity, size, shape, and texture); relational features characterizing the local neighborhood of each superpixel and distances to each class of superpixel; and relational features characterizing the population of sub-cellular objects underlying each superpixel. 188 features from each sub-cellular image object can be measured, and summarized separately for epithelial regular nuclei, epithelial atypical nuclei, epithelial cytoplasm, stromal round nuclei, stromal spindled nuclei, and background sub-cellular objects. All features can be summarized by mean, min, max, standard deviation, and sum. Measured features from sub-cellular objects include: standard morphometrical features (intensity, size, shape, texture); relational features characterizing local neighborhood of each sub-cellular object and typical distance of each object to all classes of objects; and relational features characterizing the relationships between sub-cellular objects and their parent superpixel.

In addition to computing relational features of each object to each other, global image features characterizing the proportion of each image occupied by the different classes of superpixel and sub-cellular objects can be measured.

For further discussion of the development of the diagnostic and prognostic models, and the specific factors utilized to develop these models, as relating to the embodiments and specific applications discussed herein, reference may be made to the above-referenced patent application (including the Appendices therein) to which priority is claimed. Reference may also be made to the published article to (and the supplementary information included therewith) Beck, Andrew, et. al, “Systematic Analysis of Breast Cancer Morphology Uncovers Stromal Features Associated With Survival,” Science Translational Medicine, Sci Transl Med 3, Vol. 3, Issue 108 (2011), which is, together with the references cited therein, herein fully incorporated by reference. The aspects discussed therein may be implemented in connection with one or more of embodiments and implementations of the present disclosure (as well as with those shown in the figures). Moreover, for general information and for specifics regarding applications and implementations to which one or more embodiments of the present disclosure may be directed to and/or applicable, reference may be made to the references cited in the aforesaid patent application and published article, which are fully incorporated herein by reference generally and for the reasons noted above. In view of the description herein, those skilled in the art will recognize that many changes may be made thereto without departing from the spirit and scope of the present disclosure.

Various modules and/or other circuit-based building blocks may be implemented to carry out one or more of the operations and activities described herein and/or shown in the figures. In such contexts, a “module” is a circuit that carries out one or more of these or related operations/activities. For example, in certain of the above-discussed embodiments, one or more modules are discrete logic circuits or programmable logic circuits configured and arranged for implementing these operations/activities, as in the circuit modules shown in the Figures. In certain embodiments, the programmable circuit is one or more computer circuits programmed to execute a set (or sets) of instructions (and/or configuration data). The instructions (and/or configuration data) can be in the form of firmware or software stored in and accessible from a memory (circuit). As an example, first and second modules include a combination of a CPU hardware-based circuit and a set of instructions in the form of firmware, where the first module includes a first CPU hardware circuit with one set of instructions and the second module includes a second CPU hardware circuit with another set of instructions. As another example such modules as shown in FIGS. 1 and 2 may be embodied in stored instructions executed by a processor.

Based upon the above discussion and illustrations, those skilled in the art will readily recognize that various modifications and changes may be made to the present disclosure without strictly following the exemplary embodiments and applications illustrated and described herein. Such modifications do not depart from the true spirit and scope of the present disclosure, including that set forth in the following claims.

What is claimed is:

1. A method comprising:
constructing superpixels representative of received cancer tissue image data, each superpixel including pixels from a portion of the image data;
constructing nuclear and cytoplasmic features for the superpixels based upon the image data and nuclei within the superpixels;
classifying the superpixels as being one of epithelium superpixels or stroma superpixels, based upon the nuclear and cytoplasmic features;
computing relational feature data for objects in the epithelium superpixels, the relational feature data being indicative of both morphologic and spatial relationships between the objects in the epithelium superpixels;
computing relational feature data for objects in the stroma superpixels, the relational feature data being indicative of both morphologic and spatial relationships between adjacent ones of the objects in the stroma superpixels;
constructing a prognostic model based upon the relational feature data for both the epithelium superpixels and stroma superpixels; and
predicting a survival outcome for a patient using the prognostic model and cancer tissue image data from the patient.

2. The method of claim 1, wherein computing the relational feature data for objects in the stroma superpixels includes determining at least one of the following: variability of stromal matrix intensity differences; a sum of a minimum intensity value of stromal-contiguous regions; and a measure of a relative border between spindled stromal nuclei and round stromal nuclei.

3. The method of claim 1, wherein
computing relational feature data for objects in the stroma superpixels includes determining variability of stromal matrix intensity differences between adjacent objects, and
predicting the survival outcome includes associating the determined variability of stromal matrix intensity differences with survival rate.

4. The method of claim 1, wherein computing the relational feature data for objects in the epithelium superpixels includes determining at least one of the following: standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

5. The method of claim 1, wherein constructing the prognostic model includes constructing a model based upon at least one of the following features: variability of stromal matrix intensity differences; sum of a minimum intensity value of stromal-contiguous regions; measure of a relative border between spindled stromal nuclei and round stromal nuclei; standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

6. The method of claim 1, wherein at least one of computing relational feature data for objects in the epithelium superpixels and computing relational feature data for objects in the stroma superpixels includes computing relational feature data for adjacent objects.

7. The method of claim 1, wherein computing relational feature data includes identifying morphologic and spatial relationships having a confidence interval of at least 95% for predicting the survival outcome, and computing data for adjacent objects using the identified morphologic and spatial relationships.

8. The method of claim 1, wherein constructing nuclear and cytoplasmic features includes decreasing complexity of the image data while maintaining a morphologic and spatial relationships between objects in a region within each image frame.

9. The method of claim 1, wherein constructing superpixels includes applying a series of image processing algorithms to break the image into coherent superpixels.

10. An apparatus comprising:
a circuit-based processor configured and arranged to carry out operations using a plurality of modules, the modules including
a construction module configured and arranged to construct superpixels representative of received cancer tissue image data, each superpixel including pixels from a region within the image data, and to construct nuclear and cytoplasmic features for the superpixels based upon the image data and nuclei within the superpixels,
an epithelium/stroma classifer module configured and arranged to classify the superpixels as being one of epithelium superpixels or stroma superpixels, based upon the nuclear and cytoplasmic features,
a relational module configured and arranged to
compute relational feature data for objects in the epithelium superpixels, the relational feature data being indicative of both morphologic and spatial relationships between the objects in the epithelium superpixels, and
compute relational feature data for objects in the stroma superpixels, the relational feature data being indicative of both morphologic and spatial relationships between adjacent ones of the objects in the stroma superpixels;
a prognostic module configured and arranged to construct a prognostic model based upon the relational feature data for both the epithelium superpixels and stroma superpixels, and
a survival module configured and arranged to predict a survival outcome for a patient using the prognostic model and cancer tissue image data from the patient.

11. The apparatus of claim 10, wherein the relational feature data for objects in the stroma superpixels includes at least one of the following: variability of stromal matrix intensity differences; sum of a minimum intensity value of stromal-contiguous regions; and measure of a relative border between spindled stromal nuclei and round stromal nuclei.

12. The apparatus of claim 10, wherein the relational feature data for objects in the epithelium superpixels includes at least one of the following: standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

13. The apparatus of claim 10, wherein the superpixels have less complexity than the image data and maintain a coherent appearance of the region of within each image frame.

14. The apparatus of claim 10, wherein the relational feature data for objects in the stroma superpixels includes variability of stromal matrix intensity differences.

15. The apparatus of claim 12, wherein the survival outcome is associated with a high variability of stromal matrix intensity differences.

16. A method comprising:
constructing superpixels representative of received cancer tissue image data, each superpixel including pixels from a portion the image data;
constructing nuclear and cytoplasmic features for the superpixels based upon the image data and nuclei within the superpixels;
classifying the superpixels as being one of epithelium superpixels or stroma superpixels, based upon the nuclear and cytoplasmic features;
computing relational feature data for objects in the epithelium superpixels, the relational feature data being indicative of both morphologic and spatial relationships between the objects in the epithelium superpixels;
computing relational feature data for objects in the stroma superpixels based on an assessment of differences with neighboring objects by determining variability of stromal matrix intensity differences between adjacent objects, the relational feature data being indicative of both morphologic and spatial relationships between adjacent ones of the objects in the stroma superpixels;
constructing a prognostic model based upon the relational feature data for both the epithelium superpixels and stroma superpixels; and
predicting a survival outcome for a patient using the prognostic model and cancer tissue image data from the patient.

17. The method of claim 16, wherein predicting the survival outcome includes associating the determined variability of stromal matrix intensity differences with survival rate.

18. The method of claim 16, wherein computing the relational feature data for objects in the stroma superpixels further includes determining a sum of a minimum intensity value of stromal-contiguous regions, and a measure of a relative border between spindled stromal nuclei and round stromal nuclei.

19. The method of claim 16, wherein computing the relational feature data for objects in the epithelium superpixels includes determining at least one of the following: standard deviation of intensity of epithelial superpixels within a ring of a center of epithelial nuclei; sum of a number of unclassified epithelial objects; standard deviation of a maximum pixel value for atypical epithelial nuclei; maximum distance between atypical epithelial nuclei; minimum elliptic fit of epithelial contiguous regions; standard deviation of distance between epithelial cytoplasmic and nuclear objects; average border between epithelial cytoplasmic objects; and maximum value of a minimum pixel intensity value in epithelial contiguous regions.

20. The method of claim 16, wherein at least one of computing relational feature data for objects in the epithelium superpixels and computing relational feature data for objects in the stroma superpixels includes computing relational feature data for neighboring objects.
